(19) United States
(12) Patent Application Publication
(10) Pub. No.: US 2025/0242336 A1
(43) Pub. Date: Jul. 31, 2025

(54) A CATALYST FOR THE CONVERSION OF CO2 TO CO AND PROCESS FOR THE PREPARATION THEREOF

(71) Applicant: COUNCIL OF SCIENTIFIC AND INDUSTRIAL RESEARCH, New Delhi (IN)

(72) Inventors: Thirumalaiswamy RAJA, Pune (IN); Chinnakonda Subramanian GOPINATH, Pune (IN); Nitin Bharat MHAMANE, Pune (IN); Ravi RANJAN, Pune (IN)

(21) Appl. No.: 18/698,662

(22) PCT Filed: Oct. 4, 2022
(86) PCT No.: PCT/IN2022/050886

§ 371 Date: Apr. 4, 2024

(30) Foreign Application Priority Data
Oct. 4, 2021 (IN) 202111045091

(51) Int. Cl. B01J 23/75; B01J 23/08; B01J 35/45; B01J 35/50; B01J 35/61; B01J 37/00; B01J 37/02; B01J 37/03; B01J 37/04; B01J 37/06; B01J 37/08; C01B 32/40; C21B 13/00

(52) U.S. Cl. CPC B01J 23/75; B01J 23/08; B01J 35/45; B01J 35/50; B01J 35/613; B01J 37/009; B01J 37/0236; B01J 37/031; B01J 37/04; B01J 37/06; B01J 37/086; B01J 37/088; C01B 32/40; C21B 13/0073

(57) ABSTRACT

The present invention relates to catalyst. Co₃O₄ nanocube or In₂O₃ with novel characterization features for the synthesis of CO, which is used as a reducing agent in the production of direct reduced metal from metal ore or mixture of metal oxides.

### FIELD OF THE INVENTION

The present invention relates to a catalyst for converting CO₂ to the selective production of CO. Particularly, present invention relates to a process for the preparation thereof. More particularly, the present invention relates to a catalyst with novel characterization features for the synthesis of CO, which is used as a reducing agent in the production of direct reduced metal from metal ore and/or metal oxides.

### BACKGROUND AND PRIOR ART OF THE INVENTION

Most of the sponge iron production plants are using CO as a reducing agent for the production of direct reduced iron. In this process, CO₂ is produced as a side product, which is a greenhouse gas. Steel is one of the critical materials of today's industrial world. Moreover, its production is characterized by high energy consumption along with carbon dioxide emissions. World steel production amounts to 6% of anthropogenic CO₂ emissions.

In CO₂ reduction reactions, methane is also formed. But, methane is not the desired product due to several reasons, such as high production cost, and logistic issues. Due to transportation issues, methane from many oil wells on off-shore is simply flared. It is well-known that one mole of methane formation from CO₂ requires four moles of hydrogen gas, which makes the process is not cost-effective (CO₂+4H₂→CH₄+2H₂O). Global warming potential is 84 and 72 for methane and CO₂, respectively, and hence the former traps the heat effectively and contributes more to global warming. Thus, the production of methane in CO₂ reduction should be minimized.

Reference may be made to Journal “Chem. Sci., 2020, 11, 10571-10593” wherein different metal-free catalytic CO₂ reduction processes have been reviewed. Nanochains of Co@CoO and N-doped-Co@CoO are shown to demonstrate CO₂ reduction to CO with 99% selectivity by Yin et al. (Chem. Eur. J., 24, 2157-2163 (2018)). However, the CO₂ conversion observed was between 14-19%, and higher CO₂ conversion with selective reduction to CO catalysts is still a challenge. Further the synthesis of nanochains of the said catalyst involves an arc discharge method, which is difficult to scale-up. Although CO₂ conversion may increase with temperature, nanochain structure might not be retained at high temperatures, due to agglomeration, and the activity is bound to decrease due to reduction in surface area.

Reference may be made to Journal “J. Mater. Chem. A, 8, 15675-15680 (2020)”, which demonstrated CO₂ reduction by electrocatalysis with Co₃O₄ nanoparticles on the tip of the carbon nanotubes and encapsulated by CNT (Co/CNT) used as working electrode and Pt/C was used as anode at a CO₂ flow rate of 20 ml/min. While this work employed electrocatalysis method, noble metal is an inevitable anode to be used for efficient CO₂ reduction. As the metal oxide-CNT encapsulation cannot be strong, Co₃O₄ would be visible over a period of time and how the activity changes with time is not known.

Reference may be made to Journal “Chem. Eng. J, 166, 428-434 (2011)” wherein a combination of PbO₂ and Co₃O₄ nanocubes (100:1 molar ratio) was also shown to demonstrate the suppression of oxygen evolution in electrochemical studies.

Further, it is well known that powder photocatalyst evaluation in suspension leads to decrease in activity at higher scale (Gopinath and Nalajala, J. Mater. Chem. A 9, 1353-1371 (2021)) and hence this process cannot be scaled-up.

Reference may be made to patent CN113398926A, wherein Pt/In₂O₃ catalyst preparation has been reported for CO₂ reduction with H₂ to methanol. However, no catalytic performance details are available and it is likely that activity would be poor without Pt.

Thus, there is a need to develop a cheap, simple CO₂ reduction process providing more and selective CO yield and less or no methane.

### OBJECTIVE OF THE INVENTION

The main objective of the present invention is to provide a catalyst with novel characterization features for the cost-effective and selective production of CO from CO₂ at ambient pressure. Another objective of the present invention is to provide a method for preparing the catalyst with novel characterization features useful for the selective production of CO from CO₂.

Yet another objective of the present invention is to provide a process for the selective production of CO from CO₂ by using a catalyst with novel characterization features.

Still another objective of the invention was to exemplify an integrated process for the utilization of CO₂ for the synthesis of reducing gas, which can be used for the reduction of iron ore and/or iron oxides.

Still another objective of the invention is to provide a novel process flow scheme and reactor for the reuse and recycle of formed CO₂ in processing units.

### SUMMARY OF THE INVENTION

The present invention provides a catalyst with novel characterization features for the selective production of CO from CO₂.

The present invention provides Co₃O₄ nano-cube (NC) and/or In₂O₃, catalysts for the selective production of CO from CO₂, wherein the catalysts Co₃O₄ nano-cube and/or In₂O₃ are characterized with x-ray diffraction (XRD), transmission electron microscopy (TEM), H₂-temperature programmed reduction (H₂-TPR), and valence band shift by near-ambient pressure photoelectron spectroscopy (NAPPES) under simulated reaction conditions.

The present invention provides a process for the preparation of catalysts for the selective production of CO from CO₂. The Co₃O₄ NC was synthesized by the wet chemical synthesis method reported in the literature. The template-free hydrothermal method has been adopted to prepare nano-crystalline and cubic Co₃O₄ by using Co(OAC)₂·4H₂O as a cobalt precursor. The In₂O₃ catalyst is prepared by using Indium nitrate, In(NO₃)₃.x.H₂O precursor.

Accordingly, present invention provides a metal oxide catalyst of formula MₙOₘ for a selective production of CO from CO₂
wherein M is selected from Co or In;
n=2, m=3 when M is In and n=3, m=4 when M is Co.

In an embodiment of the present invention, said catalyst is selected from
i. Co₃O₄ nano-cube (NC) having XRD peaks at 2θ=19.3, 31.5, 37, 38.8, 45, 47.91, 52.08, 55.8, 59.5, 65.4, 76.3;
ii. In₂O₃ has XRD peaks at 2θ=21.7, 30.76, 35.51, 38.00, 41.92, 45.43, 51.05, 56.03 and 60.74.

In another embodiment of the present invention, particle size of the Co₃O₄ nano-cube (NC) and In₂O₃ is in a range of 18-35 nm and 8-10 nm respectively. In yet another embodiment of the present invention, the Co₃O₄ nano-cube (NC) has surface area in the range of 20 to 30 m² g⁻¹.

In another embodiment, present invention provides a process for preparation of the catalyst Co₃O₄ nanocube [NC] as claimed in claims 1 and 2, wherein said process comprising the steps of:
a) dissolving cobalt precursor in water followed by stirring at a temperature in the range of 298-303 K for a period in the range of 5-10 mins to obtain a solution;
b) adding aqueous ammonia solution dropwise into the solution as obtained in step (a) to make pH 9.0 and stirring for a period in the range of 20 to 60 mins to obtain a reaction mass;
c) transferring the reaction mass as obtained at step (b) into an autoclave with teflon liner and maintaining a temperature in a range of 433 to 473 K for 10 hours to obtain a solution;
d) filtering and washing the solution as obtained at step (c) with water to obtain a reaction mass;
e) calcining the reaction mass as obtained at step (d) at a temperature in the range of 573 to 673 K for a period in the range of 2 to 4 hours in the air to obtain Co₃O₄ nano cube (NCs); and;
f) optionally calcining the Co₃O₄ nano cube (NCs) as obtained in step (e) in oxygen atmosphere at temperature in the range of 523-673 K for a period in the range of 12-24 hours to obtain calcined Co₃O₄ nano cube (NCs).

In yet another embodiment of the present invention, the cobalt precursor is Co(OAC)₂·4H₂O.

In yet another embodiment, present invention provides a process for preparation of the catalyst In₂O₃ cube as claimed in claims 1 and 2, wherein said process comprising the steps of:
a) dissolving indium nitrate precursor in a mixture of water and ethanol to obtain a solution;
b) adding ammonia solution in ethanol into the solution as obtained in step a) at temperature in the range of 298-303 K to get the hydroxide precipitate;
c) aging the precipitate as obtained in step b) at a temperature in the range of 343 to 363 K for a period in the range of 5 to 15 minutes to obtain a slurry;
d) cooling the slurry as obtained in step c) at temperature in the range of 298-303 K and washing the slurry with water and ethanol to obtain a mass;
e) drying the mass as obtained in step d) at a temperature in a range of 383 to 423 K for a period in the range of 6 to 14 hours followed by calcining at a temperature in the range of 673 to 773 K for a period in the range of 2 to 6 hrs to afford the catalyst.

In yet another embodiment of the present invention, the indium precursor is In(NO₃)₃·5.H₂O.

In yet another embodiment, present invention provides a process for the selective production of CO from CO₂ using the catalyst as claimed in claim 1 comprising the steps of:
a) pre-treating the catalyst as claimed in 1 to 2 in air at temperature in the range of 673 to 773 K for a period in the range of 2 to 6 h at a ramping rate in the range of 5 K·min⁻¹;
b) loading the catalyst to a fixed bed catalyst reactor and feeding CO₂:H₂ gas mixture in a ratio ranging between 1:0.67-1:7 using two different mass flow controllers;
c) reducing CO₂ at atmospheric pressure in reverse water gas shift (RWGS) reaction in the fixed bed catalyst reactor at a temperature in the range of 373 K to 923 K with constant gas hourly space velocity (GHSV) in a range of 15000-192000 h⁻¹ to obtain the CO.

In yet another embodiment of the present invention, CO gas is useful to convert metal oxide(s)/metal ore(s) to a reduced metal.

### BRIEF DESCRIPTION OF THE DRAWINGS

FIG. 1 shows XRD patterns of the (left) fresh and (right) spent Co₃O₄ catalysts. A spent catalyst was obtained after the CO₂ reduction reaction carried out at 773 K with 3:2 ratio of CO₂:H₂ feed after 12 h.

FIG. 2 illustrates (a-c) TEM and HRTEM images of Co₃O₄ which shows cubic morphology and the average particle size is found to be 18-35 nm. HRTEM of single (NC) is shown suggesting the NC catalysts are faceted in the (110) orientation and the lattice fringes corresponding to the interplanar distance of the (110) facet (d₁₁₀=0.45 nm) and (222) facet (d₂₂₂=0.25 nm). (d) TEM of spent catalyst is shown, and it exhibits near cubic or spherical morphology with same particle size as that of fresh catalyst.

FIG. 3 shows Temperature dependence CO₂ reduction activity of spinel Co₃O₄ NC evaluated with three CO₂:H₂ ratios, namely 3:2, 1:1 and 1:3. Panels a to d shows, CO₂ conversion, H₂ conversion, and selectivity of (c) CO and (d) CH₄ respectively.

FIG. 4 shows Time on stream study of CO₂ reduction with and H₂ on Co₃O₄ NC for (a) 1:5 and (b) 3:2 ratio of CO₂:H₂ at temperature 723 and 723 K, respectively. Reactants are shown in square (CO₂) and triangle (H₂) symbols and product selectivity is shown in dense (CO) and sparse (CH₄) hash-line bars.

FIG. 5 provides Temperature dependent CO₂ reduction activity of oxygen treated CO₃O₄ nano-cube evaluated with four CO₂:H₂ ratios, namely 1:0.67, 1:1, 1:2, and 1:3. (a) CO₂ conversion (b) CO selectivity (c) H₂ conversion (d) CH₄ selectivity

FIG. 6 (a) XRD patterns of fresh and spent catalyst, (b) H₂ TPR study of fresh In₂O₃ catalyst, and (c & d) HRTEM study of fresh and spent In₂O₃ catalyst respectively. Catalyst collected after the reaction with 1:3 CO₂:H₂ ratio at 773 K for 12 h is termed as spent catalyst.

FIG. 7 provides Temperature dependence of (a) CO₂ Conversion, (b) H₂ conversion, (c) CO selectivity (d) CH₄ selectivity. Reaction Conditions: Pressure: 1 bar, GHSV: 15000 H⁻¹, Gas ratio: CO₂:H₂=1:X (X=0.67, 1, 3, 5, 7)

FIG. 8 provides Time Aon stream studies of reactants conversion (CO₂ and H₂) on In₂O₃ with products selectivity (CO and CH₄) for (a) CO₂:H₂=1:0.67 (b) CO₂:H₂=1:3 ratios at 773 K temperature and atmospheric pressure; GHSV=15000 h⁻¹.

FIG. 9 shows Valence band spectrum of In₂O₃ recorded in the presence of 1:0.67 ratio of CO₂:H₂ at a total pressure of 0.1 mbar at 295 and 773 K. Note the shift in valence band at 773 K due to the oxygen vacancy formation and subsequent broadening of valence band due to electron filling.

FIG. 10 shows Valence band spectrum of Co₃O₄ recorded in presence of 1:3 ratio of CO₂:H₂ at a total pressure of 0.1 mbar at 375 and 675 K. Note the shift in valence band to lower binding energy at 675 K. This is possibly due to oxygen vacancy formation and (200) and (400) stepped facets formation due to reaction conditions.

FIG. 11 depicts the reactor system for CO₂ hydrogenation and its application for Iron ore reduction.

### DETAILED DESCRIPTION OF THE INVENTION

The present invention provides a catalyst with novel characterization features for the selective production of CO from CO₂.

The present invention provides Co₃O₄ NC and In₂O₃, catalyst for the selective production of CO from CO₂, wherein the catalysts Co₃O₄ NC and In₂O₃ are characterized with x-ray diffraction (XRD), transmission electron microscopy (TEM), H₂-temperature programmed reduction (H₂-TPR), and valence band shift by near-ambient pressure photoelectron spectroscopy (NAPPES) under simulated reaction conditions.

Further, present invention provides a process for the preparation of catalyst for the selective production of CO from CO₂. The Co₃O₄ nano-cube was synthesized by the wet chemical synthesis method reported in the literature. The template-free hydrothermal method has been adopted to prepare nano-crystalline and cubic Co₃O₄ by using Co(OAC)₂·4H₂O as a cobalt precursor. In₂O₃ catalyst is prepared by using Indium nitrate, In(NO₃)₃·5H₂O precursor.

The present invention relates to a process for the preparation of Co₃O₄ NC catalyst is provided, wherein said process comprises the steps of:
a) dissolving cobalt precursor in water and stirring at 298-303 K for 5-10 mins;
b) adding aqueous ammonia solution dropwise into the solution obtained at step a) to make pH 9.0 and stirring for 30 mins;
c) transferring the reaction mass obtained at step b) into autoclave with Teflon liner and maintaining at 453 K for 10 hours;
d) filtering and washing the resulting solution obtained at step c) with water;
e) Calcining the reaction mass at 623 K for 3 hours in air to obtain Co₃O₄ NCs; and
f) optionally calcining the Co₃O₄ NCs in oxygen atmosphere at 573 K for 24 h.

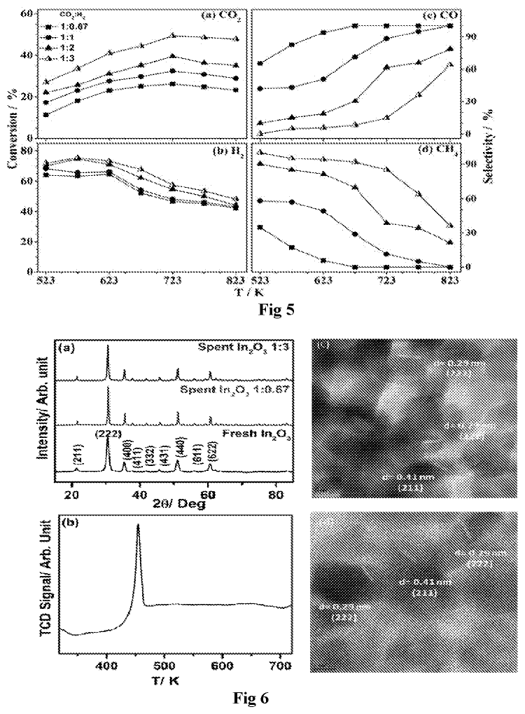

The materials prepared and obtained at the end of step € as well as step (f) were utilized as catalyst. Specifically, the inventor surprisingly found that the catalyst obtained after step f shows highly desired activity of 100% CO selectivity at relatively lower temperatures and the results are described in FIG. 5.

The present invention relates to a process for the preparation of Co₃O₄ [NC] catalyst is provided, wherein said process comprises the steps of:
a) dissolving cobalt precursor in water and stirring at 298-303 K for 5-10 mins;
b) adding aqueous ammonia solution dropwise into the solution obtained at step a) to make pH 9.0 and stirring for 30 mins;
c) transferring the reaction mass obtained at step b) into the autoclave with Teflon liner and maintaining at 453 K for 10 hours;
d) filtering and washing the resulting solution obtained at step c) with water; and
e) calcining the reaction mass at 623 K for 3 hours in the air to obtain Co₃O₄ NCs.

The present invention relates to a process for the preparation of Co₃O₄ NC catalyst is provided, wherein said process comprises the steps of:
a) dissolving cobalt precursor in water and stirring at 298-303 K for 5-10 mins;
b) adding aqueous ammonia solution dropwise into the solution obtained at step a) to make pH 9.0 and stirring for 30 mins;
c) transferring the reaction mass obtained at step b) into autoclave with Teflon liner and maintaining at 453 K for 10 hours;
d) filtering and washing the resulting solution obtained at step c) with water;
e) calcining the reaction mass at 623 K for 3 hours in air to obtain Co₃O₄ NCs; and
f) calcining the Co₃O₄ NCs in oxygen atmosphere at 573 K for 24 h.

The present invention relates to a process for the preparation of In₂O₃ catalyst is provided, wherein said process comprises the steps of:
i. dissolving indium nitrate precursor in a mixture of water and ethanol;
ii. adding ammonia solution in ethanol into the solution obtained at step i) to get the hydroxide precipitate at 298-303 K;
iii. aging the obtained slurry at step ii) at 353 K for 10 mins;
iv. cooling the slurry obtained at step iii) to 298-303 K and washing with water and ethanol;
v. drying the obtained mass at step iv) at 383 K for 12 hours and calcining at 723 K for 3 hours to afford the catalyst.

The present invention provides a process for the selective production of CO from CO₂. The process comprises of reducing CO₂ at atmospheric pressure in RWGS reaction by using catalyst (Co₃O₄ NC or In₂O₃) in a fixed bed catalyst reactor at a temperature in the range of 373 K to 923 K with constant gas hourly space velocity (GHSV) in the range of 15000-17000 h⁻¹, wherein CO₂:H₂ ratio is in the range of 1:0.67-1:7.

In another embodiment, the present invention relates to a process for the selective production of CO from CO₂ comprising the steps of:
a) pre-heating a catalyst as claimed in any one of the claims 1 to 5 in air at 723 K for 3 h at a ramping rate of 5 K·min⁻¹;
b) loading the catalyst to a fixed bed catalyst reactor and feeding CO₂:H₂ gas mixture using two different mass flow controllers;
c) reducing CO₂ at atmospheric pressure in reverse water gas shift (RWGS) reaction in the fixed bed catalyst reactor at a temperature in the range of 373 K to 923 K with constant gas hourly space velocity (GHSV) to obtain CO gas; and
d) treating the CO gas obtained in step (d) to convert metal oxide(s)/metal ore(s) to a reduced metal.

In another embodiment of the present invention, the constant gas hourly space velocity (GHSV) used in the process of the selective production of CO is in a range of 15000-192000 h⁻¹.

In another embodiment of the present invention, the CO₂:H₂ ratio used in the process of the selective production of CO is in the range of 1:0.67-5:3.

In another embodiment of the present invention, the metal oxide(s)/metal ore(s) comprises iron metal oxides or iron metal ores, cobalt oxides, manganese oxides and so on.

In another embodiment of the present invention, the treating step (d) is done at 10% H₂. 10% CO or 5% H₂+5% CO under inert conditions (N₂, He, Ne, etc.) at a heating rate of 5 K/min, attaining the temperature up to from around 530 K to 900 K to obtain reduced metal. In preferred embodiment, the metal oxide(s)/metal ore(s) reduction starts from around 530 K and completes the reduction at 900 K, more preferably, the reduction completes at 650 K, 673 K or 900 K.

Characterization of Co₃O₄ Nano-Cube

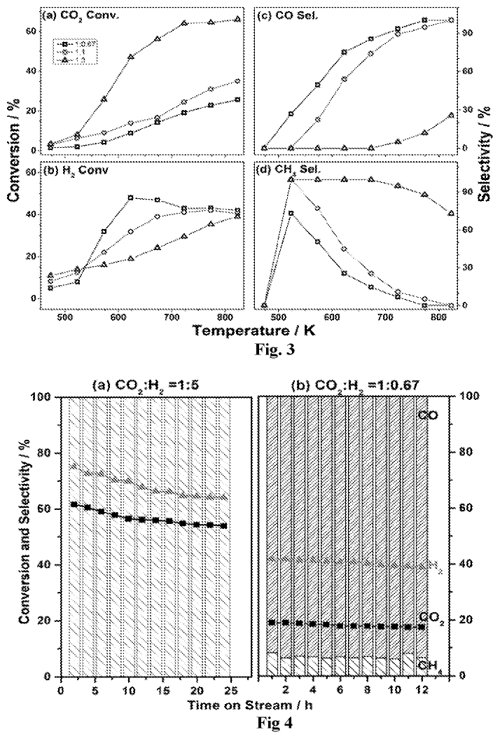

The XRD analysis of the fresh and spent catalysts (reaction performed at 773 K with 3:2 CO₂:H₂ for 12 h) sample shown in FIG. 1. The XRD pattern of fresh catalyst shows different features (FIG. 1a) at 20=19.3, 31.5, 37, 38.8, 45, 55.8, 59.5, 65.4 correspond to (111), (220), (311), (222), (400), (422), (511), (400) crystal facets of CO₃O₄ respectively. The XRD patter observed in FIG. 1a is identical to those reported in the literature (JCPDS 65-3103), supporting the catalyst is cubic (spinel) in nature. However, after the reaction at 773 K, some new facets have appeared along with few of the originally observed crystallographic facets. The intensity of the (400) facet increased and appeared as parent peak; further, peaks at 47.91, 52.08, 76.3 correspond to (101), (200), and (110) crystal facets were observed in FIG. 1 (right). Indeed, this observation suggests a restructuring of the surface and high intensity (400) facet and the growth of moderate (200) facet suggests a surface with step like structure on the surface. Above observed restructuring is retained, even after repeated reactions for at least six cycles of the reaction results shown in FIG. 3 for 1:0.67 ratio of CO₂:H₂. This observation also reiterates that the virgin (or as prepared) nanocube, which contains predominant (100) facet undergoes restructuring under the reaction conditions to the above found facets, which forms the basis for the active phase of the catalyst. This observation supports the recyclability and sustainability of the catalyst for several cycles.

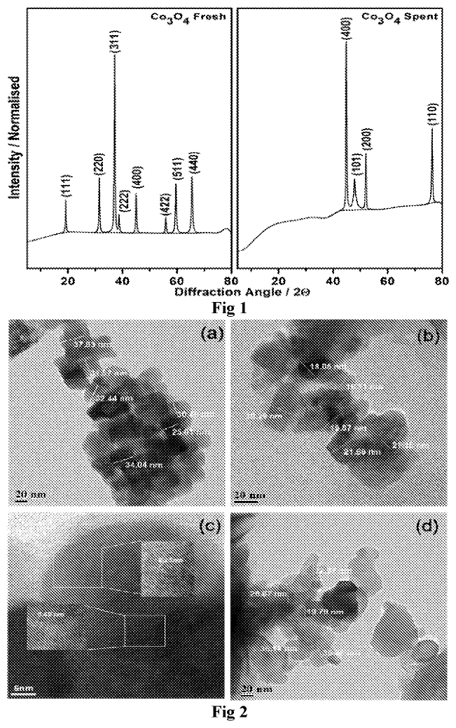

The particle size and morphology of the as-synthesized nano-crystal are identified by Transmission electron microscopy (TEM). FIG. 2 (a, b and c) reveals nano-cube (NC) morphology and facets of the Co: 04 sample. The as-prepared NC possesses particle size in the range of 18 and 35 nm, while the cubic morphology remains observed. Selected area electron diffraction result shown in FIG. 2 (c) demonstrates the crystalline nature the Co₃O₄ NCs, which is in good agreement with spectra of the sample. The TEM image demonstrates the growth of nano-cube with 0.25 nm and 0.45 nm d-spacing value obtained along (222) and (111) facet respectively, which is shown in XRD of the sample. TEM image shown for spent catalyst in FIG. 2d shows change in morphology from perfect cubic to near cubic and/or spherical shape, while the particle size remains in the range of 18-35 nm. In fact, it is to be noted that the spent catalyst results shown for XRD in FIG. 1 and the TEM in FIG. 2d are the active catalyst. Even after repeated cycling of catalyst for CO₂ reduction, no further change in the morphology or particle size was observed. This demonstrated the sustainability of the catalyst with same activity for several cycles or for long hours.

Analysis of CO₂ Reduction with H₂ Over Co₃O₄ Nano-Cube

CO₂ reduction with H₂, which is also known as reverse water gas shift reaction (RWGS), is carried out in a fix bed catalytic reactor at atmospheric pressure with spinel Co: 04 (nanocube) and temperature between 100 to 823 K with different CO₂:H₂ ratios (1:0.67 to 1:5) at gas hourly space velocity of 17000 h⁻¹. The catalyst sample (1 cm³) retained between the plug of quartz wool and ceramics bead. The results obtained from the reactor are shown in FIG. 3 for three CO₂:H₂ ratios, namely 1:0.67, 1:1 and 1:3. In the RWGS reaction CO is a desired product as it can be used directly in Fischer-Tropsch (FT) reaction, iron-ore reduction to metallic iron, and many metal making processes. Though, the methane is an undesired product in FT, it is not an issue for iron-ore reduction. Gaseous products from the outlet of the fixed bed reactor are analyzed by using Gas chromatography (GC) with both FID and TCD detectors. The CO formation is observed to be increasing with increasing reaction temperature from 523 K and above with all ratios. Maximum conversion of CO₂ and H₂ is observed around 64 and 70%, respectively, with 1:3 ratio of CO₂:H₂ at 823 K on spinel Co: 04. CH₄ shows 100% selectivity upto 673 K, and then it decreases with increase in CO selectivity above 673 K. Although CO₂ conversion is observed to be 25-35% for 1:0.67 and 1:1 CO₂:H₂ ratios above 773 K, CO selectivity is observed to be more than 94%. Indeed 100% CO selectivity was observed with 1:0.67 ratio above 773 and up to 823 K. It is to be noted that CO₂ conversion decreases marginally to 22% above 823 K, CO selectivity remains observed to be 100%. CO₂ conversion increases linearly with temperature with CO₂-rich compositions, at least up to 923 K and a marginal decrease is observed above 823 K. Hydrogen conversion also decreases above 823 K.

In another variation, Co: 04 nano-cube calcined at 573 K under pure oxygen at 573 K for 24 h and then the reaction was performed with four different CO₂:H₂ ratio, namely 1:0.67, 1:1, 1:2, and 1:3. The maximum CO₂ conversion was observed at 723 K for any CO₂:H₂ ratio. In contrast to the results shown in FIG. 3, H₂ consumption decreases from 623 K and above for all CO₂:H₂ compositions. CH₄ shows more than 90% selectivity below 673 K with CO₂:H₂=1:3 ratio. Critically, 100% CO selectivity (with no methane formation) was observed above 673 K with CO₂:H₂=1:0.67; 1:1 ratio also shows more than 90% CO selectivity from 723 K and above. 20-25% CO₂ conversion and high CO selectivity observed for CO₂:H₂=1:0.67 above 623 K demonstrates its superior performance over the results shown in FIG. 3. The CO₂ and H₂ conversion and products selectivity is shown in FIG. 5.

Indeed the reactivity observed with H₂-lean compositions with exclusive CO selelctivity ≥673 K is the most favorable condition for iron ore reduction to metallic iron, as there is no methane in the product. Further, smaller amount of hydrogen and large amount of CO₂ employed in the input feed is very attractive from the economical point as well as reducing the carbon footprint. H₂ being an expensive fuel, using smaller amount of the same for exclusive CO production is very attractive for commercial applications. Indeed, either the product stream (CO along with unspent H₂+CO₂) may be used as such for iron ore reduction; rather unspent CO₂ and/or H₂ may be recycled to produce CO in the subsequent cycles. Later step comes at a cost of separation of CO₂ and/or H₂ from the product stream, but leading to higher aggregate of CO₂ utilisation.

### Time on Stream

To evaluate the sustainability of the air calcined Co: 04 NC material for the reaction, time on stream study (TOS) study was performed for the CO₂ reduction reaction with 1:5 and 1:0.67 ratio of CO₂:H₂ at temperature 673 and 723 K for 24 and 12 h, respectively, and the result obtained are shown in FIGS. 4a and b. TOS studies has been carried out with hydrogen rich and lean compositions to measure the sustainability of the catalyst. With 1:5 ratio, CO₂ conversion drops marginally from 62% to 57% in the initial hours and then exhibit stable conversion. Similarly, H₂ conversion decreases from 57% in the initial hours to 48%; nonetheless, methane is the only product produced selectively under this conditions for 24 h. However, with 1:0.67 ratio of CO₂:H₂, CO production was observed with >90% selectivity and the remaining was methane. A marginal reduction on CO₂ and H₂ conversion was observed in in the first 4-5 hrs. and thereafter stable activity was observed (FIG. 4b). From the time on stream study with different ratios, it is clear that Co₃O₄ nano-cube catalyst is highly active and stable under CO₂ reduction at least up to 24 h.

Characterization of In₂O₃ Catalyst

XRD analyses of fresh and spent In₂O₃ catalysts are carried out to understand the bulk structure of the catalyst and the impact of CO₂ reduction reaction on it. XRD results are shown in FIG. 6a. Fresh In₂O₃ shows several diffraction features and all of them are assigned. Diffraction from (211), (222), (400), (411), (332), (431), (440), (611) and (622) facets are observed at 2θ value of 21.7, 30.76, 35.51, 38.00, 41.92, 45.43, 51.05, 56.03 and 60.74, respectively. Diffraction pattern matches very well with the cubic crystalline phase of In₂O₃ (JCPDS file no. 71-9529). XRD pattern of spent In₂O₃ catalysts, collected after carrying out the CO₂ reduction reaction with 1:0.67 and 1:3 ratio of CO₂:H₂ at 773 K for 12 h, are recorded and the results are shown in FIG. 6a. Both the spent catalysts, (spent In₂O₃ 1:0.67 and spent In₂O₃ 1:3) also show In₂O₃, and suggesting that there is no change in crystalline structure. However, diffraction features are narrower for the spent catalysts, compared to that of fresh one, indicating a possible growth of crystallites due to reaction. To confirm the growth of crystallites, average crystallites size was calculated by using the Scherrer equation. For fresh In₂O₃ sample, it was found to be 10.8 nm, however for spent In₂O₃ 1:0.67 and 1:3 catalysts, it was measured to be 19.6 and 18.3 nm, respectively. Preserving the cubic phase confirms the catalyst stability under the working reaction conditions. It is to be reiterated that after the above change observed in crystallite size, for subsequent reactions carried out on the same spent catalyst with any CO₂:H₂ reaction did not make any significant change in the XRD pattern or crystallite size. Intermittent air calcination at 623 K for 30 min was carried out, when the CO₂:H₂ ratio changes. This observation supports the recyclability and sustainability of the catalyst for several cycles, and any carbon deposition can be removed by intermittent air-calcination. However, no peak is observed for the metallic indium, hinting that catalyst did not undergo any reduction under the present reaction conditions employed for activity evaluation. H₂-TPR study is carried out to understand the reducibility of the In₂O₃ catalyst and the result is shown in FIG. 6b. H₂-TPR studies show a major and sharp reduction at 460 K. The onset of the major reduction begins at 420 K and ends at 475 K. Nonetheless, low intensity and a broad reduction feature continued up to 670 K. The sharp reduction feature observed at 460 K corresponds to the oxygen vacancy formation i.e., partial reduction of the surface sites. However, the low-intensity broad feature observed is attributed to the onset of bulk of oxygen vacancies. Under the present measurement conditions, no bulk reduction of In₂O₃ is observed.

HRTEM analysis is carried out for both the fresh as well as spent catalysts, and the results are shown in FIG. 6 (c and d). For the fresh In₂O₃ catalyst, lattice fringes for the two different planes, namely (222) and (211), are observed with lattice d-spacing values of d=0.29 nm and d=0.41 nm respectively. Same crystallographic facets ((222) and (211)), as that of fresh In₂O₃, are observed on spent catalyst also (FIG. 6d). Compared to fresh In₂O₃, an Increase in the particle size was observed for both spent catalysts. For fresh In₂O₃, average particle size was 8.5 nm; however, for spent 1:0.67 and 1:3 In₂O₃ catalysts, particle size was observed to be 26.7 and 22.2 nm, respectively. Particle size observed for spent catalyst was retained even after several cycles and no further change in particle size was observed. This reiterates the robust character of the catalyst.

Analysis of CO₂ Reduction with H₂ Over In₂O₃ Catalyst

Various CO₂:H₂ ratios employed are from 1:0.67 to 1:7, ranging from lower than the stoichiometric amount to excess amount of hydrogen by using In₂O₃ catalyst. In a typical CO₂ reduction reaction, apart from water and CO, CH₄ formation also occurs. Methane is not the desired product, due to several reasons, such as the high cost of production, transportation issues. It is well-known that one mole of methane formation from CO₂ requires four moles of hydrogen gas, which makes it a costly process (CO₂+4H₂→CH₄+2H₂O). Global warming potential is 84 and 72 for methane and CO₂, respectively, and hence the former traps the heat effectively and contributes more to global warming. Thus, the production of methane in CO₂ reduction should be minimized.

FIG. 7a shows the catalytic conversion of CO₂ with H₂ and the product selectivity of CO and CH₄ due to CO₂ reduction using In₂O₃ catalyst as a function of temperature. Irrespective of the ratio of the reactants, there is no CO₂ conversion below 573 K is observed. However, with an increase in the reaction temperature, the CO₂ conversion also increases linearly from 573 to 973 K. Some of the salient features worth underscoring are listed below: (a) The maximum CO₂ conversion is observed at 873 K for all the reactants ratios. The maximum CO₂ conversion of 72% is observed at 873 K with a 1:7 ratio, which is higher than any other ratio at the same reaction temperature. (b) Between 773 and 873 K, 1:0.67 and 1:1 ratios show a similar CO₂ conversion with the maximum conversion at 37% at 873 K. (c) Surprisingly, less than stoichiometric (1:0.67) ratio, assuming strict CO₂ reduction reaction, shows the promise of a possible best catalytic activity. Indeed, this is supported by high CO selectivity. (d) Likely the high CO₂ contact time possible with 1:0.67 (and 1:1) CO₂:H₂ ratio helps for the same conversion as that of 1:1 ratio.

FIG. 7b shows the H₂ conversion data for the CO₂ reduction reaction by using In₂O₃ catalyst. Like CO₂, H₂ conversion also shows a linear increase with increasing temperature; however, H₂ conversion decreases with the increase in the H₂ amount in the reactant ratio. Maximum H₂ conversion (51%) is observed with a 1:0.67 reactants ratio at 873 K. 573 and 623 K data shows comparable H₂ conversion for any ratio employed. Results show that CO₂ conversion increases with an increase in the H₂ in the reactant feedstock and the reaction temperature. This increase in the CO₂ conversion can be correlated with the generation of more active sites over the In₂O₃ surface with more H₂ in the reactant ratio. The ratio of conversion of CO₂:H₂ is 2:3 for 1:0.67 reactants ratio, between 723-873 K, underscoring a possible dynamic change on the catalyst surface.

FIGS. 7c and 7d show the catalytic selectivity data for CO and CH₄, respectively. The CO selectivity shows an increase with the reaction temperature for all reactants ratio; however, interestingly, a decrease in the H₂ content in the reactants leads to an increase in the CO selectivity. The maximum CO selectivity (98%) was observed with 1:0.67 ratio at 873 K and higher temperatures. An increase in the reaction temperature leads to a decrease in methane formation due to the high desorption rate of hydrogen, which prevents hydrogenation of carbon. Selectivity value and trend for both products show comparable for 1:0.67 and 1:1, and 1:3 and 1:5; indeed, CO₂ conversion also shows a similar trend. Very high (low) selectivity for CO (CH₄) with 1:0.67 also suggests removing the oxygen atom of CO₂ in the form of water rather than methane formation. Here it is to be noted that all the temperature dependent reaction study were carried out over the same catalyst. After every reaction, the catalyst is treated in air for 3 h at 773 K and used for new reaction. 100% CO selectivity is observed up to 873 K, but with a marginal decrease in CO₂ and hydrogen conversion.

### Time on Stream

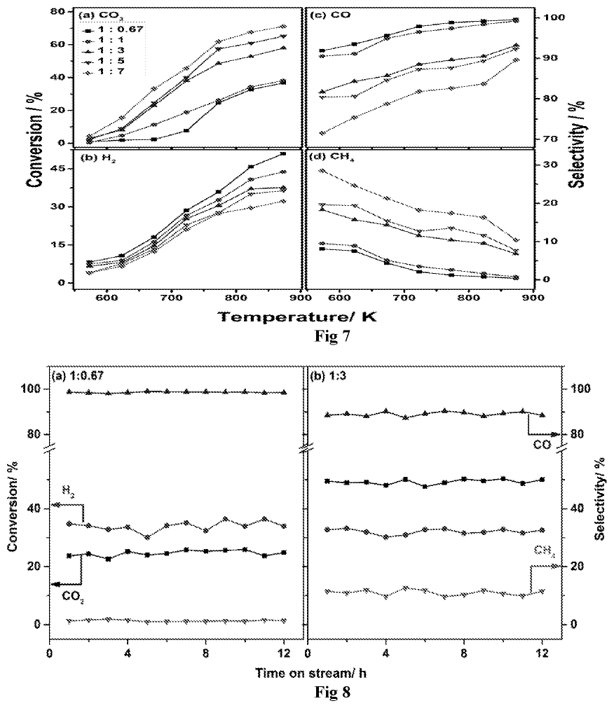

In₂O₃ catalyst surface with a CO₂:H₂=1:0.67 and 1:3 ratio shows the economically attractive catalytic activity and CO₂ reduction to CO without and with methane, respectively. Time on stream (ToS) studies is carried out for these two ratios at 773 K for 12 h, and the results obtained are shown in FIGS. 8a and 8b; this is specially to understand the stability aspects of the catalyst. For CO₂:H₂=1:0.67 ratio, stable CO₂ and H₂ conversion at 24% and 37%, respectively, is observed; under the above reaction conditions, CO and CH₄ selectivity are observed to be 98% and 2%, respectively. Same studies with 1:3 reactants ratio show a CO₂ and H₂ conversion of 49% and 32%, respectively; nonetheless, CO and CH₄ selectivity is observed to be 87% and 13%, respectively. Interestingly, the catalyst shows sustainable activity and selectivity for the entire reaction period and for both reactant's ratio. From the present ToS study, it is clear that the In₂O₃ catalyst is highly active and stable under CO₂ reduction reaction conditions. Sustainable activity with H₂ rich feeds also demonstrates the catalyst's resilient nature and not vulnerable to a total reduction of the catalyst.

Valence Band (VB) Spectral Measurements on Co₃O₄ and In₂O₃ Under CO₂ Reduction Conditions

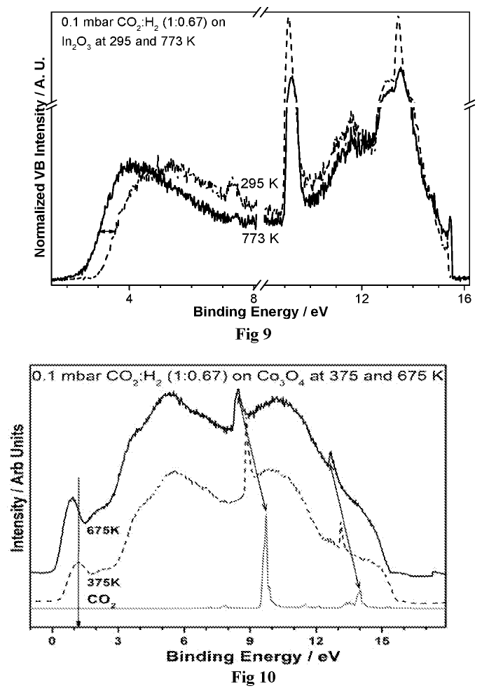

VB measurement was carried out in a near-ambient pressure photoelectron spectrometer (NAPPES) with He I radiation on In₂O₃ in the presence of 1:0.67 CO₂:H₂ mixture at a total pressure of 0.1 mbar, and the result is shown in FIG. 9. Spectral measurements are shown for 295, and 773 K. Interesting results are observed. The following points are worth underscoring: (i) Entire VB broadened up to 0.6 eV towards Fermi level at high temperatures (773 K), and highlighting a possible electron filling of VB; it is to be noted that a similar VB shift was observed on reduction of ceria [R. Jain, A. J. Dubey, M. K. Ghosalya, C. S. Gopinath, Gas-Solid Interaction of H₂—Ce_{0.95}Zr_{0.05}O₂: New Insights on Surface Participation in Heterogeneous Catalysis, Catalysis Science and Technology 6, 1746-1756 (2016)] and this lead to a change in work function too; (ii) First and low BE VB feature gains in intensity at 773 K and above and shift to low BE by 0.7 eV, at the expense of second VB feature; (iii) VB features reverts to the spectral pattern observed at 295 K on cooling in reaction atmosphere. Last point suggests the changes observed with VB are fully reversible, and it can be observed exclusively with in-situ spectral methods; no post-reaction analysis would reveal these changes. CO₂ vibrational features observed around 9 and 13 eV exhibits shifts to higher BE by 0.5 eV underscoring the nature of the catalyst surface is very different under the reaction conditions.

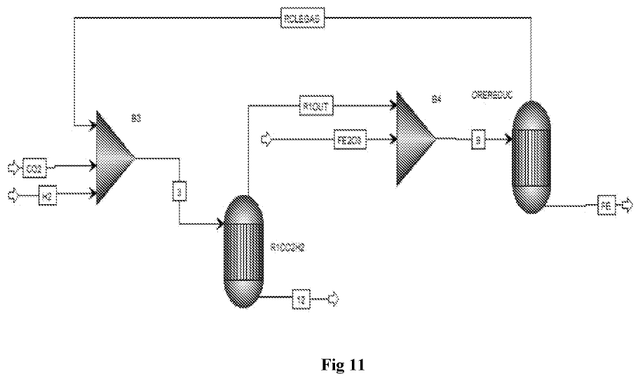

NAPPES recorded on fresh Co₃O₄ (without any treatment) with 1:0.67 CO₂:H₂ ratio as a function of temperature, and the results are shown for 375 and 675 K in FIG. 10. Gas-phase CO₂ is also plotted for reference. Main VB shifts by 0.35 eV from 1.2 eV at 375 K to 0.85 eV at 675 K. CO₂ vibrational features also shift by 0.45 eV from 375 to 675 K. Further, vibration features also broadens at high temperature, indicating a possible heterogeneity of the surface, possibly due to oxygen vacancies created. However, overall, Co₃O₄ feature is maintained even under reaction conditions, underscoring the spinel phase is the active phase. Corresponding Co 2p core level spectra exhibited typical 2:1 ratio for Co(III):Co(II) oxidation states. However, the VB shift under measurement conditions is attributed to a dynamic oxygen vacancy creation due to reaction atmosphere.

Several iron oxides and mixtures thereof were employed as starting material to reduce with H₂, CO and in a 1:1 mixture of H₂+CO. Up to 20% of H₂, CO or 1:1 H₂:CO and the rest as N₂ (as carrier gas) was employed for reduction of iron oxide(s). These experiments were carried out in a typical temperature programmed reduction (TPR) unit with 10-100 mg iron oxides. It is generally found that the reduction starts from around 523 K and up to 973 K. Various factors affects the reduction, such as nature of reductant(s), ramping rate of reduction. Employment of 100% reduction agent would facilitate the reduction at lower temperatures. Advantage of the present CO₂ reduction selectively to CO, along with unspent H₂ can be the real input reduction agent for iron oxide reduction to iron. Additionally, the product mixture is at the reaction temperature (˜773-823 K), which is exactly required for iron oxide reduction. This is likely to save significant amount of energy in the iron oxide reduction.

FIG. 11 depicts the reactor system for CO₂ hydrogenation and its application for Iron ore reduction.

### EXAMPLES

Following examples are given by way of illustration and therefore should not be construed to limit the scope of the invention.

### Example 1: Synthesis of Co₃O₄ Nano-Cube

2.5 mmol of Co(OAC)₂·4H₂O was dissolved in 125 ml water and stirred the solution at room temperature for 5 min. The aqueous ammonia was added dropwise to the cobalt precursor solution to achieve pH=9 and the solution turns blue. Afterwards, the solution obtained was further stirred for 30 mins and transferred into a 200 ml autoclave with Teflon liner and kept it at 453 K for 10 h. The resulting solution was filtered and washed with water multiple times. Finally, the sample was calcined in air at 623 K for 3 h, and Co₃O₄ nano-cubes were formed.

### Example 2: Synthesis of In₂O₃ Catalyst

Initially, the indium hydroxide was prepared by dissolving 3.05 g of Indium nitrate In(NO₃)₃·5H₂O (99.99% Sigma Aldrich) in a mixture of deionized water (12 ml) and ethanol (35 ml). The ammonia solution (9 ml of 25 wt. % in H₂O) in ethanol (27 ml) was added drop-wise under stirring conditions to get the hydroxide precipitate at 298 K. The slurry obtained was kept for aging at 353 K for 10 mins. After the aging, the slurry was kept for cooling to 298 K, washed with the water and ethanol, followed by drying at 383 K for 12 h. The dried powder was calcined at 723 K for 3 h to afford the catalyst.

### Example 3: General Process for the CO₂ Reduction in Fixed Bed Catalyst Reactor

CO₂ reduction was performed at atmospheric pressure in RWGS reaction by using catalyst (Co₃O₄ nano-cube or In₂O₃) in a fixed bed catalyst reactor at a temperature in the range of 373 K to 823 K with constant gas hourly space velocity (GHSV) in the range of 15000-19200 h⁻¹, wherein CO₂:H₂ ratio is in the range of 1:0.67-1:3. The catalyst performance was tested with a continuous flow fixed bed reactor. 1 cm³ of the catalyst was loaded in the uniform heating zone of the tubular reactor. Before the reaction, the catalyst was pre-treated in the air at 723 K for 3 h at a ramping rate of 5 K·min⁻¹. The CO₂:H₂ gas mixture was fed to the reactor using two different mass flow controllers. The temperature was set to the desired reaction temperature and it was measured with a K-type thermocouple placed at the center of the catalyst bed in the reactor tube. About 30 minutes was allowed to stabilize the reaction temperature as well as to reach the steady state, before any reaction measurement/GC analysis of the products. The gas products were analyzed using the online GC (Model: Trace 1110; Thermo scientific).

### Example 4:02 Calcined Co₃O₄ Nano-Cube Used for the CO₂ Hydrogenation Reaction in Fixed Bed Catalyst Reactor

CO₂ reduction with H₂ was performed at atmospheric pressure by using Co₃O₄ nano-cube calcined under 02 at 573 K. RWGS was carried out in a fixed bed reactor between 523 and 823 K at a constant gas hourly space velocity 19200 h⁻¹ wherein CO₂:H₂ ratio was maintained in the range of 1:0.67-1:3.

The catalyst was tested with a continuous flow fixed bed reactor with 1 cm³ of the catalyst. Catalyst evaluation was carried out, as described in example 3.

### Example 5: Reduction of Iron Oxides to Metallic Iron in H₂

FeO, Fe₂O₃, Fe₃O₄ and 1:1:1 mixture thereof oxides were reduced in TPR setup with 10% H₂ in N₂ at a heating rate of 5 K/min. It is generally found that the reduction starts from around 500 K and complete reduction to metallic iron was observed between 673 and 973 K.

### Example 6: Reduction of Iron Oxides to Metallic Iron in CO

FeO, Fe₂O₃, Fe₃O₄ and 1:1:1 mixture thereof oxides were reduced in TPR setup with (a) 10% CO in N₂ at a heating rate of 5 K/min. It is found that the reduction starts from around 550 K and complete reduction to metallic iron was observed between 650 and 900 K.

### Example 7: Reduction of Iron Oxides to Metallic Iron in CO:H₂1:1 Mixture

FeO, Fe₂O₃, Fe₃O₄ and 1:1:1 mixture thereof oxides were reduced in TPR setup with 5% H₂+5% CO in N₂ at a heating rate of 5 K/min. Iron oxide reduction starts from around 530 K and complete reduction to metallic iron was observed between 673 and 900 K.

### Example 8: Comparative Study of Co₃O₄ Nanocube Particles

Reaction Condition: Temperature: 450° C.; Pressure: 1 Atm; Reactant Molar Ratio CO₂:H₂=5:3

| Catalyst Name | CO₂ conversion | Surface area (m²g⁻¹) |
|---|---|---|
| Co₃O₄ Nano Cube | 26.2% | 26.1 |
| Co₃O₄ Nano-rod | 23.7% | 23.5 |
| Co₃O₄ Nano -sphere | 22.1% | 22.2 |

Reaction Condition: Temperature: 450° C.; Pressure: 1 atm; Reactant Molar ratio CO₂:H₂=1:3

| Catalyst Name | CO₂ conversion | Surface area (m2g−1) |
|---|---|---|
| Co₃O₄ Nano Cube | 49.4% | 26.1 |
| Co₃O₄ Nano-rod | 40% | 23.5 |
| Co₃O₄ sphere | 38% | 22.2 |

### Advantages of the Invention

The conversion of CO₂ activation reaction to highly selective CO, and exclusive CO production at 673 K and above, with lower than stoichiometric amount of hydrogen (CO₂:H₂=1:0.67) is achieved. This is a unique and commercially important aspect for exploitation of CO₂ to value added CO, to be employed for many different applications.
Low temperature and ambient pressure activation of CO₂ with wide range of CO₂:H₂ ratios and catalysts.
Byproduct of this reaction, water, will help carbon/Coke gasification reaction, which in turn will help the reduction reaction
CO₂ footprint can be minimized to a large extent by using this process. Present process also contributes to carbon-neutral economy through FT synthesis process to value added chemicals.
Catalyst composition with dynamic oxygen vacancy formation under the reaction conditions for the conversion of CO₂ to CO is novel, Scalable, and cost-effective
Nanocrystalline catalyst with well-controlled cell parameters are responsible for the selective CO formation with lower activation energy requirements.
Simple and novel process flow scheme and reactor system for the continuous use and recycle of CO₂.

1. A metal oxide catalyst of formula MₙOₘ for a selective production of CO from CO₂ wherein M is selected from Co or In;
n=2, m=3 when M is In and n=3, m=4 when M is Co, wherein particle size of the Co₃O₄ nano-cube (NC) and In₂O₃ is in a range of 18-35 nm and 8-10 nm respectively.

2. The metal oxide catalyst as claimed in claim 1, wherein said catalyst is selected from
i. Co₃O₄ nano-cube (NC) having XRD peaks at 2θ=19.3, 31.5, 37, 38.8, 45, 47.91, 52.08, 55.8, 59.5, 65.4, 76.3;
ii. In₂O₃ has XRD peaks at 2θ=21.7, 30.76, 35.51, 38.00, 41.92, 45.43, 51.05, 56.03 and 60.74.

3. The metal oxide catalyst as claimed in claim 1, wherein the Co₃O₄ nano-cube (NC) has surface area in the range of 20 to 30 m² g⁻¹.

4. A process for preparation of the catalyst Co₃O₄ nanocube (NC) as claimed in claim 1, wherein said process comprising the steps of:
a) dissolving cobalt precursor in water followed by stirring at a temperature in the range of 298-303 K for a period in the range of 5-10 mins to obtain a solution;
b) adding aqueous ammonia solution dropwise into the solution as obtained in step (a) to make pH 9.0 and stirring for a period in the range of 20 to 60 mins to obtain a reaction mass;
c) transferring the reaction mass as obtained at step (b) into an autoclave with teflon liner and maintaining a temperature in a range of 433 to 473 K for 10 hours to obtain a solution;
d) filtering and washing the solution as obtained at step (c) with water to obtain a reaction mass;
e) calcining the reaction mass as obtained at step (d) at a temperature in the range of 573 to 673 K for a period in the range of 2 to 4 hours in the air to obtain Co₃O₄ nano cube (NCs); and
f) optionally, calcining the Co₃O₄ nano cube as obtained in step (e) in oxygen atmosphere at temperature in the range of 523-673 K for a period in the range of 12-24 hours to obtain calcined Co₃O₄ nano cube.

5. The process as claimed in claim 3, wherein the cobalt precursor is Co(OAC)₂·4H2O.

6. A process for preparation of the catalyst In₂O₃ cube as claimed in claim 1, wherein said process comprising the steps of:
a) dissolving indium nitrate precursor in a mixture of water and ethanol to obtain a solution;
b) adding ammonia solution in ethanol into the solution as obtained in step a) at temperature in the range of 298-303 K to get the hydroxide precipitate;
c) aging the precipitate as obtained in step b) at a temperature in the range of 343 to 363 K for a period in the range of 5 to 15 minutes to obtain a slurry;
d) cooling the slurry as obtained in step c) at temperature in the range of 298-303 K and washing the slurry with water and ethanol to obtain a mass;
e) drying the mass as obtained in step d) at a temperature in a range of 383 to 423 K for a period in the range of 6 to 14 hours followed by calcining at a temperature in the range of 673 to 773 K for a period in the range of 2 to 12 hours to afford the catalyst.

7. The process as claimed in claim 6, wherein the indium precursor is In(NO₃)₃·5H2O.

8. A process for the selective production of CO from CO₂ using the catalyst as claimed in claim 1 comprising the steps of:
a) pre-treating the catalyst as claimed in 1 to 2 in air at temperature in the range of 673 to 773 K for a period in the range of 2 to 6 h at a ramping rate in the range of 5 K·min⁻¹;
b) loading the catalyst to a fixed bed catalyst reactor and feeding CO₂:H₂ gas mixture in a ratio ranging between 1:0.67-1:7 using two different mass flow controllers;
c) reducing CO₂ at atmospheric pressure in reverse water gas shift (RWGS) reaction in the fixed bed catalyst reactor at a temperature in the range of 373 K to 923 K with constant gas hourly space velocity (GHSV) in a range of 15000-192000 h⁻¹ to obtain the CO.

9. The process as claimed in claim 8, wherein CO gas is useful to convert metal oxide(s)/metal ore(s) to a reduced metal.
